(19) United States
(12) Patent Application Publication
(10) Pub. No.: US 2026/0360897 A1
(43) Pub. Date: Nov. 12, 2026

(54) METHOD FOR PRODUCING BATTERY ARTICLE, AND BATTERY ARTICLE PRODUCED THEREFROM

(71) Applicant: BASF SE, Ludwigshafen Am Rhein (DE)

(72) Inventors: Wei LIU, Shanghai (CN); Jian DING, Shanghai (CN); Yu Sheng LIU, Shanghai (CN); Yinghao LIU, Shanghai (CN)

(73) Assignee: BASF SE, Ludwigshafen Am Rhein (DE)

(21) Appl. No.: 19/113,464

(22) PCT Filed: Sep. 11, 2023
(86) PCT No.: PCT/EP2023/074912

§ 371 Date: Mar. 20, 2025

(30) Foreign Application Priority Data
Sep. 22, 2022 (WO) PCT/CN2022/120563

(51) Int. Cl. H01M 50/244; C08G 18/32; C08G 18/48; C08G 18/66; C08K 5/521; C09D 5/18; C09D 7/63; C09D 175/08; H01M 50/204; H01M 50/227; H01M 50/24; H01M 50/242

(52) U.S. Cl. CPC H01M 50/244; C08G 18/3206; C08G 18/4829; C08G 18/6674; C09D 5/18; C09D 7/63; C09D 175/08; H01M 50/204; H01M 50/227; H01M 50/24; H01M 50/242; C08G 2110/0066; C08G 2110/0083; C08G 2150/60; C08K 5/521

(57) ABSTRACT

The present invention relates to a method for producing battery article wherein a plurality of battery cells are potted in a potting material and the battery article prepared therefrom. The method comprises steps of: S1. providing a battery case having a plurality of battery cells arranged therein, the battery cells separate internal space of the battery case into a plurality of receiving cavities; S2. preparing a potting compound; S3. filling the potting compound into the receiving cavities, wherein relationship between total filling time (T1) and rising time (T2) of the potting compound satisfies T1<0.95*T2, preferably T1<0.8*T2; and S4. curing the potting compound to yield a potting foam; the potting compound has an initial viscosity being lower than 2500 cps at 25 °C.

### TECHNICAL FIELD

The present invention relates to a method for producing battery article, as well as the battery article prepared therefrom.

### BACKGROUND

In order to maintain battery cells in place during driving for a long time, one solution is to fill the battery pack with certain material (e.g. polyurethane), so that the battery cells are embedded in the material. Accordingly, battery pack containing such material has high impact and vibration resistance. And such material is often called as potting compound.

However, battery pack contains many components such as battery cells, bus bars, cooling pipes, which create complex shaped cavities inside the battery pack. Besides, the two components of polyurethane (“isocyanates” and “polyol”) are highly reactive. In production, it has been difficult to fill the battery pack cavities with polyurethane homogeneously in a short time.

### SUMMARY OF THE INVENTION

In view of above expectations, present disclosure provides a method for producing battery article. According to present method, the potting material can fill cavities inside the battery pack smoothly and uniformly; and surface of the foamed potting material is substantially flat. In addition, the potting material is also flame retardant.

In a first aspect, present disclosure provides a method for producing battery article wherein a plurality of battery cells are potted in a potting material, comprising the steps of
S1. providing a battery case having a plurality of battery cells arranged therein, the battery cells separate internal space of the battery case into a plurality of receiving cavities;
S2. preparing a potting compound;
S3. filling the potting compound into the receiving cavities, wherein relationship between total filling time (T1) and rising time (T2) of the potting compound satisfies T1<0.95*T2, preferably T1<0.8*T2; and
S4. curing the potting compound to yield a potting foam;
wherein the potting compound has an initial viscosity being lower than 2500 cps at 25 °C measured according to ASTM D2196-15, and the potting compound is a liquid polyurethane reaction mixture obtained by mixing
a first component comprising at least one isocyanate; and
a second component comprising
   at least one polyol (P-1) having a molecular weight of from 500 to 7000 g/mol;
   at least one chain extender having a molecular weight of less than 500 g/mol;
   at least one blowing agent; and
   at least one catalyst;
wherein at least one of the first component and the second component contains a flame retardant.

In a second aspect, present application provides a battery article prepared according to the method of above first aspect, comprising
a battery case;
a plurality of battery cells arranged within the battery case, the battery cells separate internal space of the battery case into a plurality of receiving cavities; and
polyurethane foam, which partially or completely fills the receiving cavities and the battery cells are potted in the polyurethane foam.

### DETAILED DESCRIPTION OF THE PRESENT INVENTION

In below description, further explanations to present disclosure are made with reference to embodiments to facilitate sufficient understanding for skilled person in the art. It should be understood that these embodiments are provided merely for better understanding the subject matter of present disclosure, not for making any limitations to the protection scope, applicability or embodiments as described in present claims set. It should be understood that skilled person in the art can omit, replace, or add various technical features to each embodiment based on actual needs, subject to the premise of without departing from the spirit of present disclosure. In addition, technical features described in some embodiments can be combined with technical features described in other embodiments.

Unless defined otherwise, all technical and scientific terms used herein have the same meanings as commonly understood by skilled person in the art to which present disclosure belongs.

In present disclosure, terms “comprise”, “comprising” and various variants thereof can be understood as open ended terms, which means “include but are not limited to”; in contrast, the term “consisting of” and various variants thereof excludes any component, step or procedure not specifically listed; the term “one embodiment” can be understood as “at least one embodiment”; the term “another embodiment” may be understood as “at least one other embodiment.” Other terms that may appear but are not mentioned here, unless explicitly stated, should not be interpreted or limited in a manner that is contrary to the concept on which the embodiments of present disclosure are based.

Throughout present disclosure, expressions like “a”, “an”, “the” and “one or more” are used inter-changeably and are intended to include both the plural and the singular except in cases where the singular alone is explicitly specified or is clearly indicated by the context. When the singular alone is intended for, the term “one” is typically used. The term “or” is generally intended to include the sense of “and/or” unless the content clearly dictates otherwise.

“Preferred”, “preferable” and “preferably” as used herein interchangeably refer to embodiments of present disclosure that may bring certain advantages under certain situations. However, other embodiments may also be preferred, under the same situations. Further, the recitation of one or more preferred embodiments does not mean that other embodiments are not suitable and is not intended to exclude other embodiments from the scope of present disclosure.

All percentages, parts, ratios and percentages (%) are by weight, unless otherwise specified. For example, “wt %” refers to percent by weight. And the recitation of numerical ranges by end values includes all numbers subsumed within that range (e.g., from 5 to 10 includes 5, 5.1, 5.2, 5.55, 6, 6.5, 7, 7.5, 8, 8.5, 9, 9.5, . . . 10).

Throughout present disclosure, expressions of temperature refer to the value measured under 101.325 Kpa.

Functionality is the “theoretical OH functionality” that results from the functionality of the starter molecules used. Fractional functionalities result from mixing starter molecules with different functionalities.

In present disclosure, “Potting” refers to a process of filling a liquid potting compound (e.g. polyurethane reaction mixture in present disclosure) into a container (e.g. battery case in present disclosure). The liquid potting compound poured into the container hardens and thereby protects internal components (e.g. battery cells in present disclosure) from impact and vibration.

### I. Method for Producing Battery Article

A battery article contains many components such as battery cells, bus bars, cooling pipes etc., which create complex shaped cavities inside the battery pack. It is expected that the potting compound can fill in these cavities as much as possible. In addition, it is further expected that the yielded potting foam has a substantially flat surface.

In view of these expectations, in a first aspect, present disclosure provides a method for producing battery article wherein a plurality of battery cells are potted in a potting material, comprising the steps of
S1. providing a battery case having a plurality of battery cells arranged therein, the battery cells separate internal space of the battery case into a plurality of receiving cavities;
S2. preparing a potting compound;
S3. filling the potting compound into the receiving cavities, wherein relationship between total filling time (T1) and rising time (T2) of the potting compound satisfies T1<0.95*T2, preferably T1<0.8*T2; and
S4. curing the potting compound to yield a potting foam;
wherein the potting compound has an initial viscosity being lower than 2500 cps at 25 °C measured according to ASTM D2196-15, and the potting compound is a liquid polyurethane reaction mixture obtained by mixing
a first component comprising at least one isocyanate; and
a second component comprising
   at least one polyol (P-1) having a molecular weight of from 500 to 7000 g/mol;
   at least one chain extender having a molecular weight of less than 500 g/mol;
   at least one blowing agent; and
   at least one catalyst;
wherein at least one of the first component and the second component contains a flame retardant.

Potting compound of present disclosure is a liquid polyurethane reaction mixture, which is a two-components system (i.e. a first component (also referred to as “isocyanate component”) and a second component (also referred to as “polyol component”)). In commercial application, isocyanate component and polyol component are stored separately, upon use, are delivered into a mixing chamber and mixed (e.g. statically mixing, or impingement mixing) to generate a liquid polyurethane reaction mixture. The liquid polyurethane reaction mixture is then immediately introduced into cavities of a battery article (e.g. by using high-pressure or low-pressure systems). There is no limitation on the types of suitable machine. Preferable machines have an output capacity (e.g. higher than 0.01 L/s) so that the required volume of the potting compound can be introduced into the battery articles within a relatively short period of time. The battery article can be open or closed.

During above process, directly after mixing, the isocyanate component and polyol component starts to form urethane linkage, causing viscosity of the mixture to increase, followed by polyurea reaction (generating gas bubbles) that expands and cures into a polyurethane potting foam. Consequently, the polyurethane reaction mixture can only flow for a short period of time due to high reactivity of the two components.

In order to fill the receiving cavities inside the battery article as much as possible within short time frame, present inventors found that the potting compound shall have good flowability. According to present disclosure, the potting compound (i.e. polyurethane reaction mixture) has an initial viscosity being lower than 2500 cps at a temperature of 25 °C measured according to ASTM D2196-15. Initial viscosity of polyurethane reaction mixture is measure as following: immediately after mixing the first component and the second component, determine the viscosity of the resulted polyurethane reaction mixture at a temperature of 25 °C measured according to ASTM D2196-15. Present inventors found that potting compound having such an initial viscosity has good flowability and processability, allowing the potting compound fills complex shaped cavities rapidly. Meanwhile, good flowability also facilitates the potting compound to flow flat in a short time.

Further, in order to ensure that the polyurethane reaction mixture has sufficient time to flow flat, total filling time (T1) of present disclosure is controlled being shorter than the rising time (T2) of the polyurethane reaction mixture, e.g. T1<0.95*T2. In some preferable embodiments, total filling time (T1) is shorter than 0.8 times of the rising time (T2), i.e. T1<0.8*T2. Total filling time (T1) is understood as the time from the start of filling to the completion of filling. Rising time (T2) is understood as the time from the start of mixing the two components to the start of mixture foaming. The start of mixture foaming refers to the volume expansion. According to present disclosure, rising time (T2) of the polyurethane reaction mixture is measured as following: immediately after mixing the first component and the second component, 50 g of the resulted polyurethane reaction mixture was added into a beaker (250 ml); observe and record the time at which the mixture starts to expand at room temperature (e.g. 25 °C) by naked eye. It shall be understood that rising time of polyurethane reaction mixture will be a bit prolonged when the polyurethane reaction mixture was poured into a battery case containing a plurality of battery cells at industrial level.

By controlling the total filling time (T1) being shorter than the rising time (T2), it ensures that the polyurethane reaction mixture poured into the battery cavities has a certain flow time before the mixture getting hardening. Particularly, when the total filling time (T1) is shorter than 0.8 times of the rising time (T2), the polyurethane reaction mixture is further guaranteed to have sufficient flow time.

Combination of the novel potting compound with the method as described above therefore has several advantages over the conventional method. By controlling the initial viscosity of the potting compound, the potting compound can fill in the cavities well in a short time. By controlling the total filling time being shorter than the rising time, it ensures that the polyurethane reaction mixture poured into the battery cavities has a certain flow time to flow flat before polyurethane getting hardening. Besides, the addition of flame retardant further ensures that the finished battery article has good flame retardant performance.

In some preferable embodiments, the initial viscosity of the potting compound is higher than 500 and lower than 2500 cps at a temperature of 25 °C measured according to ASTM D2196-15. When the potting compound is lower than 500, components therein (e.g. chain extender) having viscosity which is far below other components (e.g. polyol) tend to be easily separated from the potting compound and making following reaction cannot be fully operated.

Rising time of the polyurethane reaction mixture can be adjusted by changing the polyurethane recipe. In preferable embodiments, the potting compound has a rising time of higher than 30 seconds, preferably higher than 100 seconds. In order to reduce whole curing time and improve production efficiency, it is preferable that the rising time is lower than 250 seconds or 200 seconds in some embodiments. In some preferable embodiments, relationship between the total filling time (T1) and the rising time (T2) satisfies 0.2*T2<T1; for example: 0.2*T2<T1<0.95*T2, 0.2*T2<T1<0.8*T2. From practical point of view, total filling time shall be not too short (i.e. lower than 20 seconds), otherwise typical machines may not have the required output and not be able to evenly fill the required volume of potting compound in a short time.

Depending on geometry of the battery article and expected potting foam height, required volume of the potting compound is determined accordingly. The battery articles generally have a length of from 0.3 to 3 meters, a width of from 0.3 to 3 meters and a height of from 0.05 to 0.2 meters. Meanwhile, it is expected that the potted polyurethane reaction mixture is substantially flat at various locations around the battery case and has a height that is around 0.8-1.1 times the height of the receiving cavities. Accordingly, the required volume for potting varies from 1 to 90 Liters.

In some embodiments, the filling speed in Step 3 is controlled at from 0.01 L/s to 1 L/s Filling speed can be set in the spray head/nozzle. In some alternative embodiments, in Step 3, filling time per square meters is controlled at from 40 seconds to 200 seconds. Generally, the battery article has a size from 0.3 to 3 square meters. Filling time per square meters can be adjusted by controlling the battery article moving speed and filling speed. By controlling the filling speed or the filling time per square meters, it is guaranteed that the total filling time is shorter than the rising time of the polyurethane reaction mixture.

In step 4 (S4), the potting compound is cured to yield a potting foam, for example at room temperature, preferably at a temperature of from 10 °C to 35 °C, more preferably from 15 to 25 °C, for 5 to 30 minutes. The temperature is selected such that the whole curing process can be completed within 5 to 30 minutes, which is industrially advantageous.

More details and embodiments of the potting compound will be described hereinafter.

### Potting Compound

In Step 2 (S2), a potting compound is prepared.

Potting compound of present disclosure is a liquid polyurethane reaction mixture at room temperature. As explained above, the polyurethane reaction mixture comprises a first component (“isocyanate component”) and a second component (“polyol component”), which will react and then harden the polyurethane reaction mixture into polyurethane foam after mixing. Viscosity rises after mixing. In present disclosure, the potting compound has an initial viscosity being lower than 2500 cps, preferably from 500 to 2500 cps, more preferably from 600 to 1500 cps at 25 °C measured according to ASTM D2196-15. When poured into the battery article, such potting compound has sufficient flowability to well penetrate the receiving cavities inside the battery case.

The first component comprises at least one isocyanate and the second component comprises at least one polyol (P-1) having a molecular weight of from 500 to 7000 g/mol, at least one chain extender having a molecular weight of less than 500 g/mol, at least one blowing agent and at least one catalyst; and at least one of the first component and the second component contains a flame retardant.

### The First Component

The first component comprises at least one isocyanate and is liquid at room temperature. In some embodiments, the first component comprises two or more isocyanates. In some embodiments, the first component further comprises at least one flame retardant.

### Isocyanate

Present disclosure has no limitation on type of isocyanate. All known compounds having at least two isocyanate groups in the molecules are suitable. The isocyanate maybe a monomer, a prepolymer and/or a polymeric isocyanate.

Preferable isocyanates are liquid at room temperature. In some embodiments, the isocyanate has a viscosity of from 1 to 1,000 cps, more preferably from 100 to 500 cps at 25 °C measured according to ASTM D2196-15. For example, the isocyanate has a viscosity of 100 cps, 200 cps, 300 cps, 400 cps, or 500 cps.

Suitable isocyanate includes, but are not limited to, aromatic isocyanates, aliphatic isocyanates, cycloaliphatic isocyanates, and araliphatic isocyanates. Examples of suitable isocyanate includes tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate and/or dicyclohexylmethane 4,4′-, 2,4′- and 2,2′-diisocyanate, diphenylmethane 2,2′-, 2,4′- and/or 4,4′-diisocyanate (MDI), polymeric MDI, naphthylene 1,5-diisocyanate (NDI), tolylene 2,4- and/or 2,6-diisocyanate (TDI), 3,3′-dimethyl diphenyl diisocyanate, 1,2-diphenylethane diisocyanate and/or phenylene diisocyanate, and combinations thereof.

In some preferable embodiments, the isocyanates are those having two isocyanate groups. In some preferable embodiments, the isocyanates are aromatic isocyanates. Diphenylmethane diisocyanate (MDI) and/or Tolylene diisocyanate (TDI) are particularly preferred for present disclosure.

Other possible isocyanates are given by way of example in “Kunststoffhandbuch, Band 7, Polyurethane” [Plastics handbook, volume 7, Polyurethanes], Carl Hanser Verlag, 3rd edition, 1993, chapters 3.2 and 3.3.2.

The isocyanate prepolymer may be obtainable by reacting the isocyanates described above in excess with an additional polyol (P′), for example, at a temperature of from 30 to 100 °C, preferably about 80 °C. Preference is given to 4,4′-MDI together with uretonimine-modified MDI and commercial polyols based on polyesters, for example ones derived from adipic acid, or polyethers, for example ones derived from ethylene oxide and/or propylene oxide, for producing the prepolymers employed according to the invention. Preference is given to 4,4′-MDI and polyols derived from ethylene oxide and/or propylene oxide, for producing the prepolymers employed according to the invention.

The additional polyol (P′) is known to those skilled in the art and described by way of example in “Kunststoffhandbuch [Plastics handbook], Volume 7, Polyurethane [Polyurethanes]”, Carl Hanser Verlag, 3rd Edition 1993, chapter 3.1.

Examples of suitable isocyanate compounds that are commercially available include LUPRANAT® M20S (from BASF), or LUPRANAT® MIPS (from BASF).

### Flame Retardant

In order to reduce fire safety risks, according to present disclosure, at least one of the first component and the second component contains a flame retardant. And the potting compound contains one or more flame retardant(s). In some embodiments, the flame retardant is present in the first component, in the second component or in both. In some preferable embodiments, the flame retardant is present in the first component.

Present disclosure has no limitation on types of the flame retardant as long as it is liquid at room temperature. Examples of suitable flame retardant include, but are not limited to, phosphorus containing materials, nitride containing materials and sulphur containing materials.

Preference is given to the phosphorous containing materials, which include phosphate ester, such as ammonium phosphorate, ammonium polyphosphorate (APP), monoammonium phosphorate, diammonium phosphorate, trichloroethyl phosphate (TCEP), trichloropropyl phosphate (TCPP), resorcinol bisdiphenylphosphate (RDP), triphenyl phosphate (TPP) Triethyl phosphate (TEP), ammonium pyrophosphorate, triphenyl phosphate, and etc. In some more preferable embodiments, the flame retardant is liquid phosphate ester including chlorinated phosphate, such as TCPP.

Based on total weight of the potting compound, total amount of flame retardant varies from 3 to 30 wt %, preferably from 5 to 20 wt %. For example, the flame retardant is present in an amount of 3 wt %, 5 wt %, 10 wt %, 15 wt %, 20 wt %, 25 wt %, and 30 wt %, based on the total weight of the potting compound, i.e. the sum of the first component and the second component.

Potting foam containing above flame retardant has at least a V2 or higher-level flame resistance as measured according to the UL 94 Test for flammability of plastics.

### The Second Component

The second component comprises at least one polyol (P-1) having molecular weight of from 500 to 7000 g/mol, at least one chain extender having a molecular weight of less than 500 g/mol, at least one blowing agent and at least one catalyst, and the polyol (P-1) has a molecular weight of from 500 to 7000 g/mol. In some embodiments, the second component comprises two or more polyols (P-1) having a molecular weight of from 500 to 7000 g/mol. And in some embodiments, the second component further comprises at least one cross linker. In yet some other embodiments, the second component further comprises components that are not reactive to polyols, such as flame retardant, catalyst, filler, additive, auxiliaries and etc.

The second component is liquid at room temperature. In some preferable embodiments, the second component has a viscosity of from 1 to 600 cps, more preferably from 10 to 100 cps at 25 °C measured according to ASTM D2196-15.

### Polyol (P-1)

Suitable polyols (P-1) have at least two reactive groups (i.e. reactive hydrogen atoms) toward isocyanate.

Suitable polyols (P-1) are liquid at room temperature and have a molecular weight of from 500 to 7000 g/mol, preferably from 500 to 6000 g/mol, more preferably from 2000 to 6000 g/mol. For example, the polyol (P-1) has a molecular weight of 2000, 3000, 4000, 5000 or 6000 g/mol.

Examples of suitable polyol (P-1) include, but are not limited to, polyether polyol, graft polyether polyol, polyester polyol, polyolefin polyol and mixtures thereof. Preference is given to polyether polyol.

In some more preferable embodiments, the second component comprises at least one polyether polyol having a molecular weight of from 2000 to 6000 g/mol which makes the resulted polyurethane reaction mixture having good flowability.

In some more preferable embodiments, the second component comprises at least one polyether polyol having a molecular weight of from 2000 to 6000 g/mol and at least one graft polyether polyol. Addition of graft polyether polyol facilitates mechanical strength of resulted polyurethane foam.

The polyol (P-1) has a functionality of equal to or higher than 2, for example 2, 3 or 4. The polyol (P-1) may be a diol polyol, a triol polyol, tetra polyol, or a higher order polyol. In some preferable embodiments, the polyol (P-1) has a functionality of from 2 to 3. In some more preferable embodiments, the polyols (P-1) are polyether polyols having a functionality of from 2 to 3.

Examples of suitable polyol (P-1) that are commercially available include: LUPRANOL® 2095 (from BASF), LUPRANOL® 4003/1 (from BASF), LUPRANOL® 2090 (from BASF), LUPRANOL 3505/1 (from BASF), LUPRAPHEN® 3905 (from BASF), LUPRAPHEN® 3907 (from BASF), LUPRAPHEN® 3909 (from BASF), NJ 360S, NJ 330S (from NingWu).

Based on the total weight of the second component, total amount of the polyols (P-1) is from 60 to 95 wt %, preferably from 60 to 90 wt %, more preferably from 65 to 75 wt %. For example, in some embodiments, total amount of the polyols (P-1) is 60 wt %, 65 wt %, 70 wt %, 75 wt %, 80 wt %, 85 wt %, 90 wt %, 95 wt %.

### Chain Extender/Cross Linker

The chain extender has a molecular weight of less than 500 g/mol, for example, below 400, below 300, below 200, below 100 g/mol. The chain extender has two functional groups reactive toward isocyanates, for example OH—, —SH or NH2-groups. Chain extender is present in an amount of from 5 to 30 wt %, preferably from 10 to 25 wt %, more preferably from 10 to 20 wt % based on the total weight of the second component.

Examples of chain extender include monoethylene glycol (MEG), diethylene glycol (DEG), 1,2-propane diol, 1,3-propane diol (DPG), 1,4-butane diol (BDO), 1,3-butane diol, 1,5-pentane diol, 1,6-hexane diol, neopentyl glycol, tetraethylene glycol, dipropylene glycol, cyclohexane diol, and aliphatic or aromatic amine based chain extenders as aliphatic or aromatic diamines like ethylene diamine, triethylene diamine and/or diethyl toluene diamine (DETDA). Other possible low-molecular-weight chain extenders are mentioned by way of example in “Polyurethane Hand-book”, Carl Hanser Verlag, 2nd edition 1994, chapter 3.2 and 3.3.2. In some preferable embodiments, the chain extender is selected from monoethylene glycol (MEG), 1,3-propane diol (DPG) and 1,4-butane diol (BDO).

In addition to chain extender, the second component may further comprise at least one cross linker. Cross linker has at least three functional groups reactive toward isocyanates. Examples of cross linker includes 1,2,4-, 1,3,5-trihydroxycyclohexane, glycerin (GLY), trimethylolpropane (TMP), pentaerythritol, triethanolamine (TEOA), diethanolamine (DEOA), and low molecular weight hydroxyl group-containing polyalkylene oxides based on ethylene oxide and/or 1,2-propylene oxide and the aforementioned diols and/or triols. Other possible low-molecular-weight cross linkers are mentioned by way of example in “Polyurethane Handbook”, Carl Hanser Verlag, 2nd edition 1994, chapter 3.2 and 3.3.2.

If chain extenders and cross linker mixtures thereof are used, these are advantageously used in an amount of from 5 to 30 wt %, preferably from 10 to 30 wt %, based on the total weight of the second component.

In some preferable embodiments, total amount of the flame retardant and chain extender is higher than 8 wt %, preferably from 10 to 15 wt %, based on the total weight of the potting compound. When potting compound have a flame retardant and chain extender as described above falls into said weight ratio range, the yielded polyurethane foam has good elasticity to protect the batter articles from external impact and vibration.

### Blowing Agent

The second component comprises at least one blowing agent, for example, one or more blowing agents. The blowing agent preferably comprises water. In some preferred embodiments, water is used as sole blowing agent. Water reacts with isocyanates and forms carbon dioxide gas, generating bubbles inside the potting foam. Therefore, the resulted potting foam has relatively low density and is low weight.

The blowing agent may further comprise other chemical and/or physical blowing agents in the art. Chemical blowing agents are compounds which form gaseous products through reaction with isocyanate, an example being water or formic acid. Physical blowing agents are compounds which have been dissolved or emulsified in the starting materials for polyurethane production and which vaporize under the conditions of polyurethane formation. By way of example, these are hydrocarbons, halogenated hydrocarbons, and other compounds, such as perfluorinated alkanes, e.g. perfluorohexane, fluorochlorocarbons, and ethers, esters, ketones and/or acetals.

The blowing agent is present from 0.2 to 2 wt %, preferably from 0.5 to 1 wt %, based on the total weight of the second component.

### Catalyst

Catalyst greatly accelerates the reaction of the polyol (P-1) and optionally chain extender and cross linker, and also chemical blowing agent with the isocyanates. As catalysts, any catalyst known in the field of polyurethane catalysts may be used. These comprise basic amine catalysts and metal-based catalysts. In a preferred embodiment the catalyst comprises incorporable amine catalysts. In a further preferred embodiment, the catalyst comprises delayed action catalysts. Delayed action catalysts are well known in the art and provide a long open time of the reaction mixture at room temperature and a fast curing at elevated temperatures.

Incorporable amine catalysts have at least one, preferably from 1 to 8, and particularly preferably from 1 to 2, groups reactive toward isocyanates, for example primary amine groups, secondary amine groups, hydroxy groups, amides, or urea groups, preferably primary amine groups, secondary amine groups, or hydroxy groups. Incorporable amine catalysts are used mostly for the production of low-emission polyurethanes which are in particular used in the automobile-interior sector. These catalysts are known and are described by way of example in EP1888664. These comprise compounds which preferably comprise, alongside the group(s) reactive toward isocyanates, one or more tertiary amino groups. It is preferable that at least one tertiary amino groups of the incorporable catalysts bear at least two aliphatic hydrocarbon moieties, preferably having from 1 to 10 carbon atoms per moiety, particularly preferably having from 1 to 6 carbon atoms per moiety. It is particularly preferable that the tertiary amino groups bear two moieties selected mutually independently from methyl and ethyl moiety, and bear another organic moiety. Examples of incorporable catalysts that can be used are bisdimethylaminopropylurea, bis(N,N-dimethylaminoethoxyethyl) carbamate, dimethylaminopropylurea, N,N,N-trimethyl-N-hydroxyethylbis(aminopropyl ether), N,N,N-trimethyl-N-hydroxyethylbis(aminoethyl ether), diethy-lethanolamine, bis(N,N-dimethyl-3-aminopropyl)amine, dimethylaminopropylamine, 3 dimethyaminopropyl-N,N-dimethylpropane-1,3-diamine, dimethyl-2-(2-amino¬ethoxyethanol), and (1,3-bis(dimethylamino) propan-2-ol), N,N-bis(3-dimethylaminopropyl)-N-isopropanolamine, bis(dimethylaminopropyl)-2-hydroxyethylamine, N,N,N-trimethyl-N-(3 aminopropyl)bis(amino¬ethyl ether), 3-dimethylaminoisopropyldiisopropanolamine, and mixtures thereof.

Examples for delayed action catalysts are carboxylic salt used of a conventional basic amine catalyst. The carboxylic salts of the basic amine catalysts for example are obtained here by mixing the amine catalysts with carboxylic acids, optionally in presence of an alcohol as ethylene glycol. If an alcohol which falls under the definition of a chain extender or a cross linker the amount is considered when calculating the amount of cross linker and chain extender in the reaction mixture.

Conventional, non-incorporable amine catalysts may comprise amidines, such as 2,3 dimethyl-3,4,5,6-tetrahydropyrimidine, tertiary amines, such as triethylamine, tributylamine, dimethylbenzylamine, N methyl, N ethyl, and N cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl) urea, dimethylpiperazine, 1,2 dimethylimidazole, 1 azabicyclo[3.3.0]octane, and preferably 1,4-diazabicyclo[2.2.2]octane, and alkanolamine compounds, such as triethanolamine, triisopropanolamine, N methyl and N ethyldiethanolamine, and dimethylethanolamine.

Suitable metal based catalysts comprise organometallic compounds, preferably organotin compounds, such as tin(II) salts of organic carboxylic acids, e.g. tin(II) acetate, tin(II) octoate, tin(II) ethylhexoate, and tin(II) laurate, and the dialkyltin(IV) salts of organic carboxylic acids, e.g. dibutyltin diacetate, dibutyltin dilaurate, dibutyltin maleate, and dioctyltin diacetate, and also bismuth carboxylates, such as bismuth (III) neodecanoate, bismuth 2-ethylhexanoate, and bismuth octanoate, or a mixture thereof. The organometallic compounds can be used alone or preferably in combination with strongly basic amines. In a particularly preferred embodiment, catalysts used comprise or consist of delayed action catalysts and especially preferred incorporable delayed action catalysts.

If catalysts are used, these can by way of example be used at a concentration of from 0.001 to 5% by weight, in particular from 0.05 to 2% by weight, as catalyst or, respectively, catalyst combination, based on the weight of component (b).

### Other Components

The second component may further contain fillers, other additives and/or auxiliaries. Fillers can be organic or inorganic fillers known in the art. For example, inorganic fillers include silicate minerals, metal oxides, such as alumina, titanium oxides and iron oxides. Examples of auxiliaries and/or additives used include surface-active substances, foam stabilizers, cell regulators, external and internal release agents, fillers, pigments, dyes, flame retardants, antistatic agents, hydrolysis stabilizers and fungistatic and bacteriostatic substances.

Further details of the starting materials used can be found, for example, in the Kunststoffhandbuch [Plastics Handbook], volume 7, Polyurethane [Polyurethanes], edited by Günter Oertel, Carl-Hanser-Verlag, Munich, third edition 1993, chapter 5, Polyurethanweichschaumstoffe [Flexible polyurethane foams].

The first component and the second component are mixed in a weight ratio of 80:100 to 110:100. The isocyanate index is from 80 to 120, for example, 80, 90, 100, 110, and 120.

### II. Battery Article Prepared According to the Method

In a second aspect, present disclosure intends to provide a battery article prepared according to the method as described in the first aspect, comprising
a battery case;
a plurality of battery cells arranged within the battery case, the battery cells separate internal space of the battery case into a plurality of receiving cavities; and
polyurethane foam, which partially or completely fills the receiving cavities and the battery cells are potted in the polyurethane foam.

The battery article comprises a battery case and a plurality of battery cells arranged within the battery case. The battery cells sperate internal space of the battery case into a plurality of receiving cavities. There is no limitation on the shape of the battery case and the battery cells. Polyurethane foam fills in the receiving cavities partially or completely. In some embodiments, the polyurethane foam fills 80% to 100% of the height of the battery article.

The polyurethane foam of present disclosure is elastic and thus provides continuous cushioning and excellent shock absorption. Elastic polyurethane foam protects internal components of a battery article from external shock and vibration. In some preferable embodiments, the polyurethane foam has a compressive yield strength of from 0.3 to 6 MPa, preferably from 0.5 to 3.5 MPa measured according to ASTM D 1621 (stress at 10%). Therefore, battery articles partially or completely filled/potted with such polyurethane foams have excellent impact resistance and vibration resistance. And the battery articles can pass the vibration test measured according to SAE J2380-2013 (Normal Test) or GBT 31467.3-2015.

The polyurethane foam can be either “closed-cell”, where most of the bubbles remain intact; or “open-cell”, where the bubbles inside the foam are interconnected.

In some embodiments, the polyurethane foam has a hardness of from 50 to 90 Shore A measured according to ISO 7619. Polyurethane foams with such hardness are particularly preferred, which enable the polyurethane foam to provide mechanical stability to the internal components.

In some embodiments, the polyurethane foam has a relatively low density, for example, from 350 to 900 g/L, preferably from 530 to 680 g/L. Polyurethane foams having such densities have a relatively low weight, which is particularly advantageous for reducing the overall battery article weight.

### Examples

The present invention will now be further described with reference to Examples and Comparative Examples, which are not intended to limit the present invention.

Materials

| Description | Abbreviation | Remark | Source |
|---|---|---|---|
| Polyol (P-1) | LUPRANOL ® | Polyether polyol has a number | From BASF |
| | 2090 | average molecular weight (Mn) | |
| | | of 6000 g/mol and a functionality | |
| | | (Fn) of 3, obtainable with a | |
| | | trifunctional starter molecule | |
| | LUPRANOL ® | Polyether polyol with a number | From BASF |
| | 4003/1 | average molecular weight of | |
| | | 4000 g/mol and a functionality of | |
| | | 3, obtainable with a trifunctional | |
| | | starter molecule | |
| | LUPRANOL ® | Polyether polyol with a number | From BASF |
| | 1000 | average molecular weight of | |
| | | 2000 g/mol and a functionality of | |
| | | 2.9, obtainable with a | |
| | | trifunctional starter molecule | |
| | CHE-5602 | Polyether polyol with a number | From Changhua |
| | | average molecular weight of | |
| | | 3000 g/mol and a functionality of | |
| | | 3, obtainable with a trifunctional | |
| | | starter molecule | |
| Chain extender | Mono | — | From BASF |
| | Ethylene | | |
| | Glycol (MEG) | | |
| Cross linker | Glycerin | — | From BASF |
| | (GLY) | | |
| Isocyanate | LUPRANAT ® | Fn = 2.7; NCO value = 31 | From BASF |
| | M20S | | |
| | LUPRANAT ® | Fn = 2; NCO value = 23 | From BASF |
| | MIPS | | |
| Flame | RDP | Phosphate based FR additive | From BASF |
| retardant | TEP | Phosphate based FR additive | From BASF |
| Blowing agent | Water | — | — |
| Catalyst | DABCO ® | Delayed-action catalyst | From EVONIK |
| | BL17 | | |
| | LUPRAGEN ® | TEDA | From BASF |
| | N201 | | |
| Surfactant | TEGOSTAB ® | — | From BASF |
| | B8738 LF2 | | |

### Test Methods

Density (g/L): GB/T 6343-2008
Shore A hardness: ISO 7619
Viscosity (cp): ASTM D2196-15
Flammability: UL-94
Compressive yield strength: ASTM D 1621, stress at 10%
Vibration test: SAE J2380-2013 (Normal Test) & GBT 31467.3-2015.

### Preparation Examples of the Potting Compounds

The first component and the second component of the polyurethane compound of Examples 1-3 (Ex. 1-3) and Comparative Examples 1-3 (Com. Ex. 1-3) were prepared according to table 1 by mixing corresponding components and were stored in separate containers. Upon use, the two components were delivered into a mixing chamber under 150 bar in a mixing ratio as shown in Table 1 and were impingement mixed to generate a liquid polyurethane reaction mixture (i.e. potting compounds). The second components of Examples 1~4 and comparative Examples 1-2 have an initial viscosity as listed in below Table 1. Initial viscosity of the obtained liquid polyurethane reaction mixtures of Examples 1~4 and comparative Examples 1-2 are also listed in Table 1.

As shown in Table 1, initial viscosity of the liquid polyurethane reaction mixture of examples 1~4 varies from 700-900 enabling the resulted liquid polyurethane reaction mixture having desired flowability.

In comparison, initial viscosity of the liquid polyurethane reaction mixture of comparative example 1 is 3000 which is too sticky to have enough flowability for flowing flat. Initial viscosity of the liquid polyurethane reaction mixture of comparative example 2 is 200. However, such low viscosity is brought by introducing high amount of chain extender having low viscosity. Yet, because of high amount of chain extender, the resulted liquid polyurethane reaction mixture is prone to phase separation since viscosity of the chain extender is far below other components in the second component, like polyol (P-1), allowing the high amount of chain extender to be easily separated from the polyurethane mixture. The non-uniform distribution of chain extender prevents uniform reaction with isocyanates which is undesired.

TABLE 1

| | | | | | |
|---|---|---|---|---|---|
| | | | | Com. | Com. |
| Ex. 1 | Ex. 2 | Ex. 3 | Ex. 4 | Ex. 1 | Ex. 2 |

The First component

| | | | | | | |
|---|---|---|---|---|---|---|
| Isocyanate | 45 | 45 | 45 | 45 | 45 | 45 |
| M20S | | | | | | |
| Isocyanate | 45 | 45 | 45 | 45 | 45 | 45 |
| MIPS | | | | | | |
| Flame | 10 | 10 | 10 | 10 | 10 | 10 |
| Retardant, | | | | | | |
| RDP | | | | | | |

The Second component

| | | | | | | |
|---|---|---|---|---|---|---|
| Polyol (P-1) | 60.3 | 65.3 | 55.3 | 50.3 | 60.3 | 45.3 |
| 2090 | | | | | | |
| Polyol (P-1) | 10 | 15 | 10 | 10 | 30 | 10 |
| 4003/1 | | | | | | |
| Polyol (P-1) | — | — | — | 5 | — | — |
| CHE 5602 | | | | | | |
| Polyol (P-1) | — | — | 10 | 10 | — | — |
| 1000 | | | | | | |
| Chain extender | 6 | 15 | 10 | 10 | 0 | 35 |
| MEG | | | | | | |
| Cross linker | 14 | — | 5 | 5 | 0 | 5 |
| Glycerin | | | | | | |
| Blowing agent, | 1 | 1 | 1 | 1 | 1 | 1 |
| water | | | | | | |
| Surfactant | 3.5 | 3.5 | 3.5 | 3.5 | 3.5 | 3.5 |
| B8738 | | | | | | |
| Catalyst | 0.1 | 0.1 | 0.1 | 0.1 | 0.1 | 0.1 |
| BL17 | | | | | | |
| Catalyst | 0.1 | 0.1 | 0.1 | 0.1 | 0.1 | 0.1 |
| N201 | | | | | | |
| Flame | 5 | — | — | 5 | 5 | 5 |
| retardant | | | | | | |
| TEP | | | | | | |
| Mixing ratio | 100:100 | 100:100 | 100:100 | 100:100 | 100:100 | 100:100 |
| by Weight | | | | | | |
| (the first | | | | | | |
| component:the | | | | | | |
| second | | | | | | |
| component) | | | | | | |

Viscosity (cp) at 25 °C

| | | | | | | |
|---|---|---|---|---|---|---|
| The second | 1600 | 1200 | 1450 | 1420 | 4200 | 300 |
| component | | | | | | |
| The liquid | 900 | 700 | 850 | 850 | 3000 | 200 |
| polyurethane | | | | | | |
| reaction | | | | | | |
| mixture | | | | | | |
| (Initial | | | | | | |
| viscosity) | | | | | | |

### Preparation Examples of Battery Articles

The battery pack comprises a battery case and has a size of 40 cm (width)×150 cm (length)×11 cm (height). 120 battery cells were placed inside the battery case, i.e. on the bottom of the battery case. The battery cell has a diameter of 4.6 cm and a height of 8 cm. The battery case has a surface size of 0.6 m². The battery pack further comprises other components. Battery cells and other components separate internal space of the battery case into a plurality of receiving cavities.

The liquid polyurethane reaction mixtures of example 1 and example 3 prepared according to above Table 1 was injected into the receiving cavities immediately after mixing via spray head. Specific process conditions were listed in below Table 2. The liquid polyurethane reaction mixtures of example 1 and example 3 were processed under different conditions as shown in Ex. 1-1, Ex. 1-2, Ex. 3-1 and Ex. 3-2.

After injection, the battery packs were kept at room temperature (25 °C) for curing. The liquid polyurethane reaction mixtures gradually hardened into polyurethane foam. As appropriate, trim the top polyurethane foam and close the upper cover of the battery case.

Rising time (T2) of the polyurethane reaction mixture was measured as following: immediately after mixing the first component and the second component, 50 g of the resulted polyurethane reaction mixture was added into a beaker (250 ml); then observe and record the time at which the mixture starts to expand at 25 °C by naked eye. It shall be understood that rising time of polyurethane reaction mixture will be a bit prolonged when the polyurethane reaction mixture was poured into the battery case containing a plurality of battery cells.

Evaluation results of each example were also recorded in Table 2.

TABLE 2

| | Ex. 1-1 | Ex. 1-2 | Ex. 3-1 | Ex. 3-2 |
|---|---|---|---|---|
| Total volume of the | 15 | 15 | 15 | 15 |
| PU reaction | | | | |
| mixture (L) | | | | |
| Rising time (T2) of | 160 | 160 | 130 | 130 |
| the PU reaction | | | | |
| mixture (s) | | | | |
| Total filling time | 40 | 15 | 30 | 300 |
| (T1) (s) | | | | |
| Filling speed (L/s) | 0.375 | 1 | 0.5 | 0.05 |
| Filling time per | 66.67 | 25 | 50 | 500 |
| square meters | | | | |
| (s/m²) | | | | |
| Cure temperature | 25 °C | 25 °C | 25 °C | 25 °C |
| (°C) | | | | |
| Evaluation | Excellent | Not acceptable | Excellent | Not acceptable |
| | The cured PU foam | Due to the short filling time and | The cured PU foam | The spray head moves too slow, |
| | has a substantially | the excessively fast movement of | has a substantially | causing the polyurethane foam |
| | flat upper surface | the spray head, the filling is | flat upper surface | surface to be high on one side |
| | over the entire batter | uneven. | over the entire batter | and low on the other side of the |
| | case. | The cured PU foam is high at both | case. | battery case. |
| | | ends and low in the middle of the | | The unevenness also results in |
| | | battery case. | | poor vibration resistance of the |
| | | The unevenness also results in | | cured PU foam. |
| | | poor vibration resistance of the | | |
| | | cured PU foam. | | |

Mechanical properties of the obtained polyurethane foams of Examples 1-1 and 3-1 were determined. As shown in table 3, the cured polyurethane foams of both Example 1-1 and Example 3-1 have good mechanical properties. Both the cured polyurethane foam of example 1-1 and example 3-1 can pass V-2 flame retardant test (UL94) and example 1-1 can even pass V-1. Besides, these foams also pass vibration test (GBT-31467.3-2015).

TABLE 3

| | Ex. 1-1 | Ex. 3-1 |
|---|---|---|
| Density (g/L) | 550 | 450 |
| Hardness (Shore A) | 85 | 80 |
| Compressive yield | 0.8 | 2 |
| strength (MPa) | | |
| FR UL 94 | V-1 | V-2 |
| Vibration test- SAE | Pass | Pass |
| J2380-2013 | | |
| Vibration test- GBT | Pass | Pass |
| 31467.3-2015 | | |

Although the embodiments and examples of the present disclosure are described above, skilled person in the art should understand that they are only for illustrative purpose, and are not intended to limit the protection scope of the present disclosure. The protection scope of the present disclosure is defined by the appended claims. Skilled person in the art can make various modifications, equivalent substitutions or improvements to these embodiments without departing from the scope and spirit of the present disclosure, but these modifications, equivalent substitutions or improvements fall within the protection scope of the present disclosure.

1. A method for producing a battery article comprising a plurality of battery cells potted in a potting material, the method comprising:
filling a potting compound into a plurality of receiving cavities in a battery case comprising a plurality of battery cells arranged therein, the battery cells separating an internal space of the battery case into said plurality of receiving cavities, wherein a relationship between a total filling time (T1) and a rising time (T2) of the potting compound satisfies T1<0.95*T2; and
curing the potting compound to yield a potting foam;
wherein the potting compound has an initial viscosity lower than 2500 cps at 25 °C measured according to ASTM D2196-15, and the potting compound is a liquid polyurethane reaction mixture obtained by mixing
a first component comprising at least one isocyanate; and
a second component comprising
at least one polyol (P-1) having a molecular weight of from 500 to 7000 g/mol;
at least one chain extender having a molecular weight of less than 500 g/mol;
at least one blowing agent; and
at least one catalyst;
wherein at least one of the first component and the second component contains a flame retardant.

2. The method for producing a battery article according to claim 1, wherein the potting compound has a rising time of higher than 30 seconds.

3. The method for producing a battery article according to claim 1, wherein the total filling time (T1) and the rising time (T2) of the potting compound satisfies 0.2*T2<T1.

4. The method for producing a battery article according to claim 1, wherein a filling speed of said potting material is from 0.01 L/s to 1 L/s.

5. The method for producing a battery article according to claim 1, wherein a filling time of said potting material per square meters is 40 s to 200 seconds.

6. The method for producing a battery article according to claim 1, wherein the potting compound is cured at a temperature of from 10 °C to 35 °C.

7. The method for producing a battery article according to claim 1, wherein the polyol (P-1) has a molecular weight of from 500 to 6000 g/mol, and the polyol (P-1) has a functionality of equal to or higher than 2.

8. The method for producing a battery article according to claim 1, wherein the polyol (P-1) is present in an amount from 60 to 95 wt % based on a total weight of the second component.

9. The method for producing a battery article according to claim 1, wherein the second component further comprises at least one cross linker.

10. The method for producing a battery article according to claim 1, wherein the chain extender is present in an amount from 5 to 30 wt % based on a total weight of the second component.

11. The method for producing a battery article according to claim 1, wherein the chain extender is at least one selected from a group consisting of ethylene glycol (MEG), butanediol (BDO), and propanediol (DPG).

12. The method for producing a battery article according to claim 1, wherein the flame retardant is liquid, and the flame retardant is present in an amount from 3 to 30 wt % based on a total weight of the potting compound.

13. The method for producing a battery article according to claim 1, wherein the flame retardant comprises liquid phosphate ester.

14. The method for producing a battery article according to claim 1, wherein a total amount of the flame retardant and chain extender is higher than 8 wt % based on a total weight of the potting compound.

15. The method for producing a battery article according to claim 1, wherein the blowing agent comprises water and is present in an amount from 0.2 to 2 wt % based on a total weight of the second component.

16. The method for producing a battery article according to claim 1, wherein the catalyst comprises a delayed action catalyst.

17. A battery article prepared according to the method of claim 1, comprising
a battery case;
a plurality of battery cells arranged within the battery case, the battery cells separating an internal space of the battery case into a plurality of receiving cavities; and
polyurethane foam, which partially or completely fills the receiving cavities and the battery cells are potted in the polyurethane foam.

18. The battery article according to claim 17, wherein the polyurethane foam has a compressive yield strength of from 0.3 to 6 MPa measured according to ASTM D 1621 (stress at 10%).

19. The battery article according to 17, wherein the polyurethane foam has a hardness of from 50 to 90 Shore A measured according to ISO 7619.

20. The battery article according to claim 17, wherein the polyurethane foam has a density of from 350 to 900 g/L, preferably from 530 to 680 g/L.

21. The battery article according to claim 17, wherein the polyurethane foam fills 80% to 100% of the height of the receiving cavities.
